(19) United States
(12) Patent Application Publication
(10) Pub. No.: US 2006/0079365 A1
(43) Pub. Date: Apr. 13, 2006

(54) Roller chain with large plate height

(76) Inventors: Thomas Fink, Dachau (DE); Michael Panas, Munchen (DE); Markus Aurnhammer, Munchen (DE); Holger Frank, Taufkirchen (DE); Stefan Belmer, Anzing (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/214,167

(22) Filed: Aug. 29, 2005

(30) Foreign Application Priority Data
Sep. 10, 2004 (DE) 202004014091.8
Jul. 15, 2005 (DE) 20200501198.8

(51) Int. Cl. F16G 13/02

(52) U.S. Cl. 474/231; 474/230; 474/234

(57) ABSTRACT

A roller chain of a metallic material, with alternating inner and outer chain links which are respectively joined together via a chain joint, whereby the outer chain links comprise two parallel outer plates, joined together by means of two parallel joint pins, and the inner chain links comprise two parallel inner plates, joined together by means of two parallel joint sleeves, a joint pin of an outer chain link extends in each case through a joint sleeve of an inner chain link to form a chain joint and a rotatable roller is arranged on the outer surface of the joint sleeve, whereby a size ratio of the height of the outer and inner plates to the external diameter of the roller is greater than 1.4, and a size ratio of the mean thickness of the inner plate to the mean thickness of the outer plate is greater than 1.1.

### REFERENCE TO RELATED APPLICATIONS

This disclosure claims priority to German Application No. 202004014091.8, filed Sep. 10, 2004, and German Application No. 202005011198.8, filed Jul. 15, 2005.

### FIELD OF THE DISCLOSURE

### Description

This disclosure relates to a roller chain of a metallic material with inner and outer chain links which alternate and are in each case joined to one another via a chain joint, whereby the outer chain links comprise two parallel outer plates joined together by two parallel joint pins and the inner chain links comprise two parallel inner plates joined together by two parallel joint sleeves, a joint pin of an outer chain link in each case extending through a joint sleeve of an inner chain link to form a chain joint and a rotatable roller is arranged on the outer surface of the joint sleeve.

### BACKGROUND OF THE DISCLOSURE

Examples of roller chains can be found in U.S. Pat. No. 5,382,199 A, GB 2398852 A, EP 0257661 A and U.S. Pat. No. 5,799,479 A.

This type of roller chain is very often employed, in particular for applications in which good acoustic properties of the chain are required. Due to their rotating support, the-rollers arranged for rotation on the joint sleeves ensure a correspondingly low level of noise generation when meeting a chain wheel than with a comparable sleeve-type chain. However, compared to a sleeve-type chain of comparable size, the roller chain has the disadvantage that it has less fatigue strength than the sleeve-type chain. For each application consideration must be given of whether the acoustic or fatigue strength problem is to be given priority. With some uses, such as for example the use of the roller chain as a timing chain on an internal combustion engine, substantial spatial problems arise so that the clearance for the use of the most standardized chains is very restricted.

### SUMMARY OF THE DISCLOSURE

It is therefore the object of this disclosure to provide a roller chain mentioned in the introduction, which has a better fatigue strength with furthermore good acoustic properties.

This object is solved according to the disclosure in that a size ratio of the height of the outer and inner plates to the external diameter of the roller is larger than 1.4 and a size ratio of the mean thickness of the inner plate to the mean thickness of the outer plate is larger than 1.1. Comparison of a standardized roller chain with a chain according to the disclosure in which the external diameters of the rollers are identical shows that the roller chain according to the disclosure has substantially higher outer or inner plates. Also the enlargement of the thickness of the inner plate contributes to a noticeable potential increase in the fatigue strength due to this different type of arrangement. Due to the fact that particularly the higher outer and inner plates and the somewhat thicker inner plate (particularly with otherwise essentially the same dimensions) can be used with most chain drives, this has in addition the advantage that the increase in fatigue strength arises only due to the higher outer and inner plates and the thicker inner plates. A sleeve-type chain and possibly also a standard roller chain could thus be replaced by such a roller chain according to the disclosure without needing to modify anything on the chain drive in any way. The large height of the outer or inner plates can be taken up without problem by the usual tensioning displacements which are provided by tensioning bars and chain adjusters. Changes, in particular to the sprockets, are not carried out when the pitch and the external diameter of the rollers remain the same. Summarizing it can be said that the relevant cross-section of the inner and outer plates, important for the fatigue strength, is enlarged compared to a standard roller chain without the function being impaired. In contrast to the solution according to the disclosure in the design of US 2004/0192482 A1 the joint area is enlarged, whereby a better wear resistance is obtained. In contrast this disclosure aims to improve the fatigue strength, in particular with moderate mean tensions. The mean thickness of the inner plates and outer plates is taken to mean the thickness of a plate of the same weight (for the same outer contour, size and inner contour (openings) and the same material) and plane-parallel side surfaces. According to this definition, for example the contoured inner plates according to U.S. Pat. No. 5,799,479 exhibit essentially the same mean thickness as the associated outer plates. Also, the drawing inaccuracies of FIG. 6 in this publication cannot convey such a technique.

Most existing chain drives facilitate another increase in the fatigue strength of the roller chain without the sprockets having to be modified. In this respect the chain, according to one variant, exhibits a size ratio of the mean thickness of the inner plate to the mean thickness of the outer plate of more than 1.2. The upper limit should be a maximum of 1.5 or preferably 1.4 without having to make changes to most chain drives.

In particular with roller chains for use as timing chains on internal combustion engines it is advantageous if, according to one variant, the outer and inner plates exhibit the same height. For this reason it is also advantageous if the outer and inner plates exhibit a uniform height, symmetrical about a longitudinal center line, between the respective rounded ends. This definition means that the upper and lower edges of the plates run parallel to one another and at the same distance to the longitudinal center line of the chain.

One variant has been found to be particularly favorable with regard to the combination effect of acoustic properties and fatigue strength, in which the size ratio of the height of the outer and inner plates to the external diameter of the roller is greater than 1.45 and smaller than 1.55.

Preferably for this the size ratio of the height of the inner and outer plates to the external diameter of the roller is selected to be greater than 1.48 and smaller than 1.52. With the use of such a range it can also be assumed that this roller chain can be used as a replacement in an existing chain drive.

A replacement of the roller chain for a standard roller chain can be particularly easily achieved when, according to one variant, a size ratio of the external diameter of the roller to the pitch of the chain has a maximum of 0.71. Although the wear properties of the chain joint cannot be increased by this type of measure, this roller chain however offers a higher durability for moderate mean loads compared to a standard roller chain.

Furthermore, a size ratio of the height of the inner and outer plates to the pitch of the roller chain can be from 0.97 to 1.1.

Furthermore, a size ratio of the external diameter of the joint pin and the pitch can be up to a maximum of 0.39. Also, in this way it is ensured that essentially no enlargement of the joint area is needed in comparison to a normal chain.

A further influence on the fatigue strength can be made when, according to one embodiment, a size ratio of the height of the outer plate and the external diameter of the joint pin is greater than 2.7, preferably 2.85 and is less than 3.1, preferably 3.0.

Another size ratio, which is used for an additional geometrical optimization of the roller chain for one variant, refers to the height of the inner plate and the external diameter of the joint sleeve. This size ratio is greater than 1.9, preferably 2.05, and smaller than 2.3, preferably 2.15.

Since a roller chain according to the invention is to be principally used as a timing chain in an internal combustion engine, in one embodiment a steel material, in particular a tempering steel, is used as the metallic material for the outer and inner plates, joint sleeves, joint pins and rollers.

With a single roller chain the minimum breaking force compared to the minimum standard breaking force of a single roller chain to DIN 8187 with the same pitch, same external diameter of the roller and from the same material can be increased by a factor of at least 1.4.

Furthermore, the single roller chain can exhibit a mean reduction of the airborne noise of at least 1 dB and the structure-borne noise of at least 2 dB in comparison to a single roller chain to DIN 8187 with the same pitch, same external diameter of the roller, same material and the same test conditions in the range from 2000 to 5000 rpm when used as a timing chain on an internal combustion engine.

### BRIEF DESCRIPTION OF THE DRAWINGS

In the following, this disclosure is explained in more detail based on a drawing. The following are shown:

FIG. 1 shows a roller chain according to the disclosure as a full section, and

FIG. 2 shows the roller chain from FIG. 1 in a side view.

### DETAILED DESCRIPTION OF THE DISCLOSURE

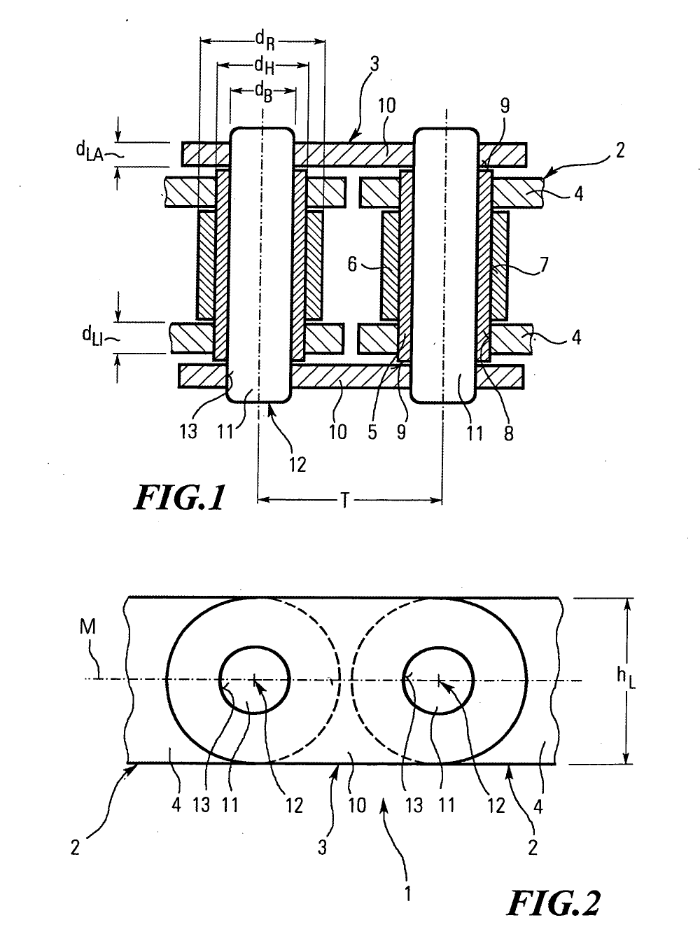

The roller chain 1 illustrated in FIG. 1 comprises alternating inner chain links 2 and outer chain links 3.

Each inner chain link 2 consists of two parallel inner plates 4 arranged spaced to one another, two parallel joint sleeves 5, which are spaced to one another and join the inner plates 4 to one another and two rollers 6, of which in each case one is supported for rotation on the outer surface 7 of a joint sleeve 5. The joint sleeves 5 are pressed into openings 8 in the inner plates 4, whereby the face sides 9 of the joint sleeves 5 protrude slightly over the inner plates 4. The roller 6 exhibits a length which is slightly smaller than the inner spacing between the two inner plates 4.

Each outer chain link 3 comprises two outer plates 10 arranged at a parallel distance to one another and two joint pins 11 arranged at a parallel distance to one another. Each joint pin 11 extends through in each case one joint sleeve 5 of the inner chain link 2 to form a chain joint 12. The joint pins 11 are pressed into openings 13 on the outer plates 10 and protrude at the side with their ends slightly over the outer plates 10. The inner spacing between the two outer plates 10 of an outer chain link 3 is slightly greater than the length of the joint sleeves 5.

From FIG. 2 it can be seen that the inner plates 4 and outer plates 10 exhibit a height h_{L}. The joint pin 11 has an external diameter of d_{B}, the joint sleeve 5 an external diameter of d_{H} and the roller 6 an external diameter of d_{R}. The upper and lower edges of an inner plate 4 and an outer plate 10 run in each case parallel to one another at in each case the same distance (symmetrically) to the chain longitudinal center line M. All inner and outer plates 4, 10 are therefore equally high.

According to the disclosure the size ratio of the height h_{L} of the outer or inner plates 10, 4 to the external diameter d_{R} of the roller 6 should be greater than 1.4. With this embodiment the height h_{L} is equal to 9.5 mm, whereas the external diameter d_{R} of the roller 6 is 6.35 mm. This corresponds to a size ratio of 1.496 (according to the disclosure, this size ratio is greater than 1.4, preferably between 1.45 and 1.55, and more preferably between 1.48 and 1.52).

The external diameter dB of the joint pin 11 in this embodiment is 3.35 mm. That corresponds to a size ratio between h_{L} and d_{B} of 2.923 (according to the disclosure greater than 2.7, preferably 2.85 and smaller than 3.1, preferably 3.0). The external diameter d_{H} of the joint sleeve 5 in this case is 4.55 mm.

This corresponds to a size ratio for these two values of 2.088 (according to the disclosure greater than 1.9, preferably 2.05 and smaller than 2.3, preferably 2.15).

The thickness d_{LI} of the inner plates 4 is in this case 1.5 mm and the thickness d_{LA} is in this case 1.2 mm. This corresponds to a size ratio of 1.25 (according to the disclosure this size ratio is greater than 1.1, preferably greater than 1.2, but a maximum of 1.5).

The pitch T of the roller chain 1 is 9.525 mm (other pitches can of course be used with appropriate retention of the size ratio).

In this case this means that a size ratio of the external diameter d_{R} of the roller 6 to the pitch T of the roller chain 1 is in this case 0.67 (according to the disclosure this size ratio may be up to 0.71).

The size ratio of the height h_{L} of the inner and outer plates 4, 10 to the pitch T of the roller chain 1 is in this case 0.997 (according to the disclosure this size ratio can be from 0.97 to 1.1).

A size ratio of the external diameter d_{B} of the joint pin 11 and the pitch T is in this case 0.35 (according to the disclosure this size ratio may be up to 0.39).

The correct selection of the size ratio should take place such that the minimum breaking force compared to the minimum standard breaking force of a single roller chain according to DIN 8187 with the same pitch T, same external diameter d_{B} of the roller 6 and of the same material is increased by at least the factor 1.4. With this present embodiment this factor is even noticeably higher. The comparison takes place in regard to a roller chain DIN 8187-06B-1 from an equivalent steel material, e.g. 42CrMo4 or C45E.

Furthermore, the single roller chain according to the disclosure exhibits a mean reduction of the airborne noise of at least 1 dB and of the structure-borne noise of at least 2 dB in comparison to a single roller chain according to DIN 8187 with the same pitch T, same external diameter d_{R} of the roller, the same material and the same test conditions in the range of 2000 to 5000 rpm when used as a timing chain on an internal combustion engine. The comparison was carried out on a V6 towing simulation. A roller chain DIN 8187-06B-1 in a steel material, in particular 42CrMo4 or C45E, acted as the comparison chain. Over the whole speed range for a chain according to the disclosure the airborne noise remained below the noise level of the standard chain. This is essentially the case also with the measurement of the structure-borne noise. An adjustment only occurred with some resonant speed ranges, but there were no exceeding values in the stated speed range. The new chain is therefore substantially quieter and also more durable.

Owing to the greater plate height h_{L} in the ratio to the external diameter d_{R} of the roller 6 compared to the standard roller chains, apart from the retention of the good acoustic properties of a roller chain 1, also a substantial increase in the fatigue strength is produced. Such a chain can therefore in particular be used for the timing chain on internal combustion engines. Furthermore, this roller chain 1 can be used without further ado as a replacement chain for a chain drive which has previously used a sleeve-type chain, which exhibits a sleeve external diameter which is equal to the external diameter d_{R} of the roller 6. The fatigue strength then achieves similar values. However, through the use of the roller chain 1 the acoustic properties can be significantly improved compared to the sleeve-type chain.

We claim:

1. Roller chain (1) of a metallic material, with comprising alternating inner and outer chain links (2, 3) which are respectively joined together via a chain joint (12), the outer chain links (3) having two parallel outer plates (10), joined together by means of two parallel joint pins (11), the inner chain links (2) having two parallel inner plates (4), joined together by means of two parallel joint sleeves (5), a joint pin (11) of an outer chain link (3) extending in each case through a joint sleeve (5) of an inner chain link (2) to form a chain joint (12), a rotatable roller (6) arranged on the outer surface of the joint sleeve (5), a size ratio of a height (h_{L}) of the outer and inner plates (4, 10) to an external diameter (d_{R}) of the roller (6) being greater than 1.4, and a size ratio of a mean thickness of the inner plate to a mean thickness of the outer plate being greater than 1.1.

2. Roller chain (1) according to claim 1, wherein the size ratio of the mean thickness (d_{LI}) of the inner plate (10) to the mean thickness (d_{A}). Of the outer plate (4) is greater than 1.2.

3. Roller chain (1) according to claim 1, wherein the size ratio of the mean thickness (d_{LI}) of the inner plate (4) to the mean thickness (d_{LA}) of the outer plate (10) is at most 1.5.

4. Roller chain (1) according to claim 1, wherein the outer and inner plates (4, 10) are of equal height (h_{L}).

5. Roller chain (1) according to claim 1, wherein the outer and inner plates (4, 10) between the respectively rounded ends are a uniform height (h_{L}) symmetrical to a longitudinal center line.

6. Roller chain (1) according to claim 1, wherein the size ratio of the height (h_{L}) of the outer and inner plates (4, 10) to the external diameter (d_{R}) of the roller (6) is greater than 1.45 and smaller than 1.55.

7. Roller chain (1) according to claim 1, wherein the size ratio of the height (h_{L}) of the inner and outer plates (4, 10) to the external diameter (d_{R}) of the roller (6) is greater than 1.48 and smaller than 1.52.

8. Roller chain (1) according to claim 1, wherein a size ratio of the external diameter (d_{R}) of the roller (6) to a pitch (T) of the roller chain (1) is at most 0.71.

9. Roller chain (1) according to claim 1, wherein a size ratio of the height (h_{L}) of the inner and outer plates (4, 10) to the a pitch (T) of the roller chain (1) is in a range from approximately 0.97 to 1.1.

10. Roller chain (1) according to claim 1, wherein a size ratio of an external diameter (d_{B}) of the joint pin (11) and a pitch (T) of the roller chain is at most 0.39.

11. Roller chain (1) according to claim 1, wherein a size ratio of the height (h_{L}) of the outer plate (10) and an external diameter (d_{B}) of the joint pin (11) is greater than 2.7, and smaller than 3.1.

12. Roller chain (1) according to claim 1, wherein a size ratio of the height (h_{L}) of the inner plate (4) and an external diameter (d_{H}) of the joint sleeve (5) is greater than 1.9 and smaller than 2.3.

13. Roller chain (1) according to claim 1, wherein the outer and inner plates (4, 10), joint sleeve (5), joint pins (11) and roller (6) consist of a steel material.

14. Roller chain (1) according to claim 1, wherein the roller chain is a single roller chain, and the size ratio of at least one of the height (h_{L}) of the outer and inner plates (4,10) to the external diameter (d_{R}) of the roller (6), and the mean thickness of the inner plate to the mean thickness of the outer plate, is selected such that the minimum breaking force compared to the minimum standard breaking force of a single roller chain according to DIN 8187 with the same pitch (T), the same external diameter (d_{R}) of the roller (6) and of the same material is increased at least by a factor of 1.4.

15. Roller chain (1) according to claim 1, wherein the roller chain is a single roller chain, and the size ratio of at least one of the height (h_{L}) of the outer and inner plates (4.10) to the external diameter (d_{R}) of the roller (6). and the mean thickness of the inner plate to the mean thickness of the outer plate, is selected such that the single roller chain (1) exhibits a mean reduction of the airborne noise of at least 1 dB and of the structure-borne noise of a least 2 dB in comparison to a single roller chain according to DIN 8187 with the same pitch (T), the same external diameter (d_{R}) of the roller, the same material and the same test conditions in the range 2000 to 5000 rpm when used as the timing chain on an internal combustion engine.

16. Roller chain (1) according to claim 3, wherein the size ratio has a maximum of 1.4.

17. Roller chain (1) according to claim 11 wherein the size ratio is greater than 2.85 and smaller than 3.0.

18. Roller chain (1) according to claim 12, wherein the size ratio is greater than 1.9 and smaller than 2.15.

19. Roller chain (1) according to claim 13, wherein the steel material is a tempering steel.
